(19) United States
(12) Patent Application Publication
(10) Pub. No.: US 2014/0140089 A1
(43) Pub. Date: May 22, 2014

(54) LIGHTING DEVICE

(71) Applicant: Morton Graham, Lancashire (GB)

(72) Inventor: Morton Graham, Lancashire (GB)

(21) Appl. No.: 14/126,972

(22) PCT Filed: Jun. 20, 2012
(86) PCT No.: PCT/GB2012/051424

§ 371 Date: Jan. 13, 2014

(30) Foreign Application Priority Data
Jun. 20, 2011 (GB) 1110341.3

(51) Int. Cl. F21K 99/00

(52) U.S. Cl. CPC F21K 9/58
USPC 362/555; 362/235

(57) ABSTRACT

A lighting device comprises a clear acrylic rod provided with a diffusive reflective strip along one side. Light is emitted into the rod by way of an LED provided at one end of the rod. Most of this light travels along the rod having one or more total internal reflection off the sides until it encounters the reflective strip. At this point, the light is diffusely reflected back across the rod and thereby provides a diffuse beam of light in a desired direction for use in illumination. In order to prevent light emitted from the LED directly exiting the rod and thereby creating a potential hazard, side guards are provided. The extent of the side guards is selected such that all rays a emitted directly from the LED are blocked.

The present invention relates to a lighting device and in particular a lighting device adapted to diffusely reflect light emitted by one or more light emitting diodes (LEDs).

Recent developments in LED technology have lead to a use of LEDs as replacements for incandescent bulbs, fluorescent tubes and the like in illumination solutions. In this context, LEDs offer the potential benefits of reduced cost and increased energy efficiency. Since LEDs offer a relatively intense and relatively discrete light source, for most applications it is necessary to provide some arrangement for diffusing the emitted light.

One such arrangement is disclosed in U.S. Pat. No. 7,819,567 wherein a lighting device comprises a transparent acrylic or glass rod with a series of bores drilled in parallel through a part of the rod and spaced apart along its length. Each bore contains a pair of LEDs mounted such that their light is emitted substantially axially along the rod. Additionally, a reflective strip is disposed along the rod to reflect a beam of light outwardly from the rod in a direction parallel to the axes of the bores. The bulk of the light emitted by the LEDs is totally internally reflected from the sides of the rod one or more times before being diffusely reflected, in a desired direction, by the reflective strip.

Such an arrangement is relatively complex and provides a danger that some of the light emitted by the LEDs will directly escape the rod, particularly, if there has been relative movement between the rod and the LED mounts. The dangers associated with direct escape of emitted light have increased as LED technology has advanced. In many instances, direct light from an LED is sufficiently intense to cause retinal damage in humans.

It is an object of the present invention to provide a lighting device that at least partially overcomes or alleviates some or all of the above problems.

In accordance with a first aspect of the invention, there is provided a lighting device comprising: a substantially transparent body; a reflector provided along the body; an end face having one or more LEDs mounted thereon so as to emit light into the body; and side guards provided at the end of the body adjacent to the or each LED and covering the side of the body such that they substantially block the escape of light directly emitted from the LEDs that would not be totally internally reflected from the side of the body.

This arrangement provides a relatively simple lighting device construction which reduces the danger of direct light emissions from LEDs escaping.

The or each LED may be adapted to emit light over any broad or narrow range within the electromagnetic spectrum, as desired or as appropriate.

The or each LED may be mounted upon one or more portions of printed circuit board (PCB) mounted on the end face. The end face may be adapted to incorporate or act as a heat sink for the or each LED. To facilitate this, the end face may be partially or wholly comprised of metal.

The interior of the side guards may comprise a non reflective surface, a diffusely reflective surface or a combination thereof. The extent of the side guards may be determined from consideration the mounting position of the or each LED and the refractive index of the body. The side guards may be substantially parallel to the sides of the body, if desired. The end cap may form part of a housing for mounting the lighting device.

The body may be formed from any suitable material. Typically the body may be formed from glass or more preferably, acrylic.

The body may have any suitable form. Preferably the body is substantially elongate. Most preferably, the body is in the form of an elongate rod. The rod may have any suitable cross-section. Preferably, the rod has a substantially circular cross-section. In other embodiments alternative rod cross-sections may be utilised if required or desired.

The reflector may be a diffuse reflector and in particular may be a diffusely reflective strip. The strip may be a white tape or white material applied to or attached to the body. If the body is elongate, the reflector may be elongate and may be provided along the side of the body and parallel to the axis of the body.

In some embodiments, the device may be provided with one or more additional reflectors. In particular, an end reflector may be provided at the end of the body opposite the end face. The end reflector may be a diffuse reflector or a mirror reflector. In the event that the end reflector is a mirror reflector, it may be provided within side guards as described herein.

In another alternative embodiment, an end face having one or more LEDs mounted thereon and associated side guards may be provided at either end of the body.

In accordance with a second aspect of the invention, there is provided a lighting unit comprising one or more substantially transparent bodies, the or each body having a reflector provided along the body; a housing for retaining the or each body in a desired position wherein the housing is adapted to provide, at least one end of the or each body: an end face having one or more LEDs mounted thereon so as to emit light into the body; and side guards covering the side of the body adjacent to the end face such that they substantially block the escape of light directly emitted from the LEDs that would not be totally internally reflected from the side of the body.

This thereby provides a lighting unit incorporating one or more lighting devices of the first aspect of the present invention. Of course, the lighting unit of the second aspect of the present invention may incorporate any or all features described in connection with the lighting device of the first aspect of the present invention, as desired or as appropriate.

The housing may comprise one or more side panels. The side panels may be provided to cover portions of the body between side guards. The side panels may be adapted to help collimate light from the reflector.

In embodiments comprising more than one body, the bodies may be adapted such that they are arranged substantially adjacent to one another or substantially spaced apart. In such embodiments, the plurality of bodies may be arranged such that they lie along a common axis or along parallel axes to each other body or to adjacent bodies. Alternatively, in such embodiments each body may be adapted to be orientated at an angle with respect to the adjacent body. In one such embodiment, the bodies may be rods arranged along sides of a polygonal housing. In other such embodiments, the housing may be adapted to hold one or more bodies arranged in a pattern relative to one another. The pattern may correspond to a letter, numeral or symbol.

In order that they are clearly understood, specific embodiments of the invention will now be described, by way of example only, with reference to the accompanying drawings, in which:

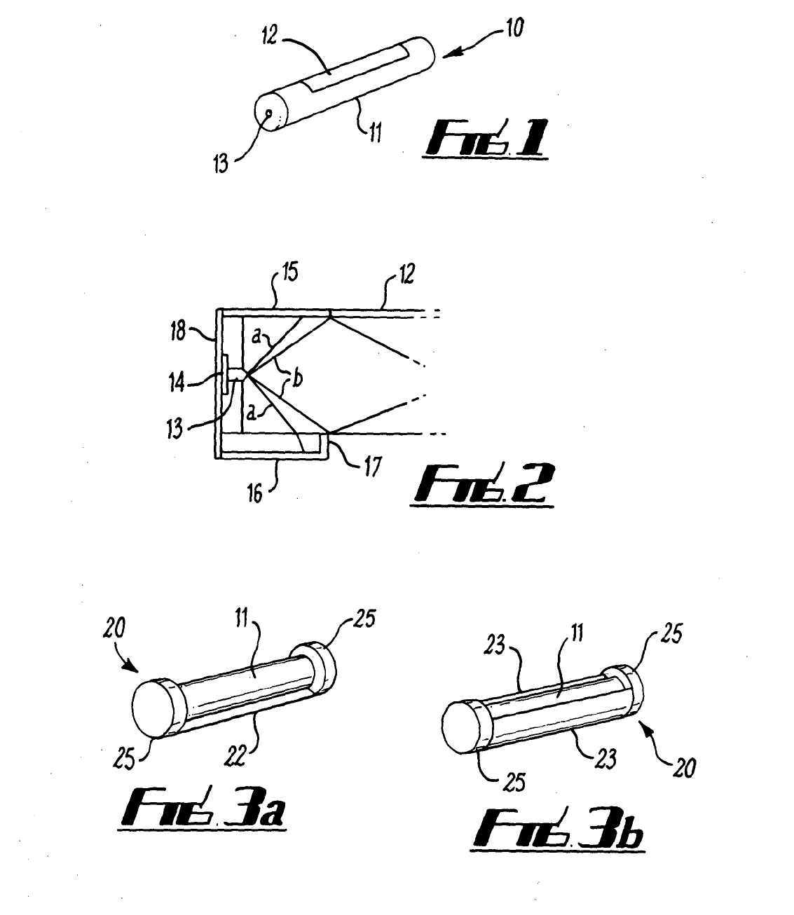

FIG. 1 is a schematic illustration of a lighting device according to the present invention;

FIG. 2 is a cross-sectional view of the body of the device of FIG. 1, illustrating the provision of side guards according to the present invention; and

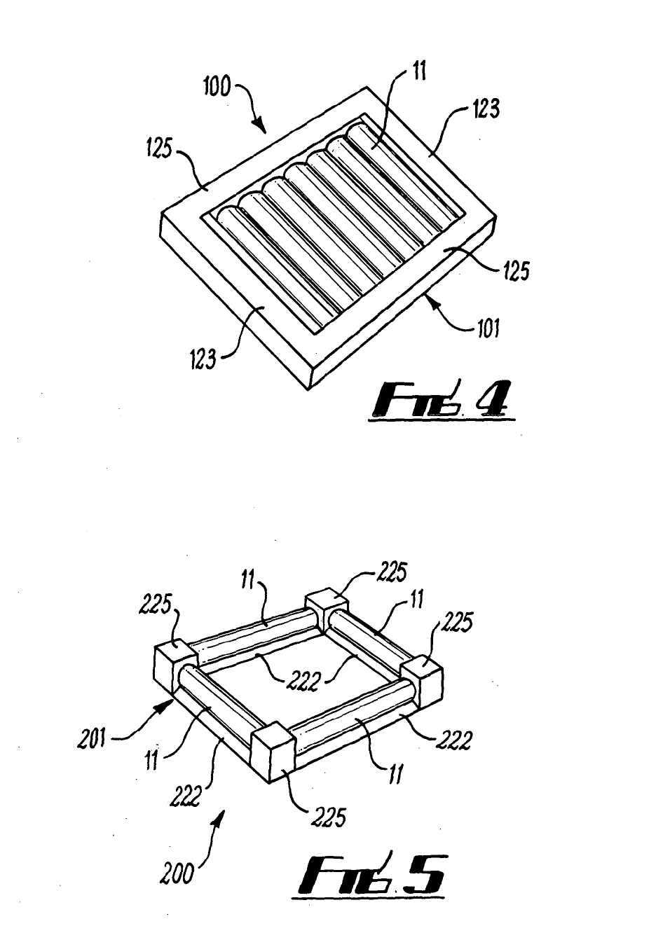

FIG. 3a is a schematic illustration of a lighting unit incorporating a lighting device according to FIG. 1;

FIG. 3b is a schematic illustration of a lighting unit incorporating a lighting device according to FIG. 1;

FIG. 4 is a schematic illustration of a lighting unit incorporating one or more lighting devices according to FIG. 1; and

FIG. 5 is a schematic illustration of an alternative embodiment of a lighting unit incorporating one or more lighting devices according to FIG. 1.

Turning now to FIG. 1, a lighting device 10 comprises a clear acrylic rod 11 provided with a diffusive reflective strip 12 along one side. Light is emitted into the rod 11 by way of an LED 13 provided at one end of the rod. Typically, the LED may be mounted on a PCB 14. Light is emitted by the LED into rod 11. Most of this light travels along the rod having one or more total internal reflection off the sides until it encounters the reflective strip 12. At this point, the light is diffusely reflected back across the rod 11 and thereby provides a diffuse beam of light in a desired direction for use in illumination.

In the present invention, in order to prevent light emitted from the LED directly exiting the rod 11 and thereby creating a potential hazard, side guards 15, 16 are provided. The side guards 15, 16 are shown in more detail in FIG. 2. In particular, the side guard 15 illustrates one embodiment of and the side guard 16 illustrates an alternative embodiment. In practice, the lighting device may incorporate one type of side guard 15, 16 or a combination of both, as required or desired. Side guard 15 extends substantially parallel to the rod 11, adjacent to the side of rod 11 either in contact with rod 11 or leaving only a narrow air gap therebetween. Side guard 16 is predominantly spaced apart from the rod 11 except for an end section 17 which is in contact with or leaves only a narrow air gap therebetween.

The function of the side guards 15, 16 is illustrated by the example rays a, b emitted by LED 13. Ray a is an example of ray which has an angle of incidence upon the side of rod 11 less than the critical angle for total internal reflection. As such, light from the ray a passes out of the rod 11 and is blocked from propagating further by side guard 15, 16. In contrast, ray b has an angle of incidence upon the side of rod 11 equal to the critical angle for total internal reflection. As such, light from the ray passes out of the rod 11 is totally internally reflected within rod 11. The extent of the side guards 15, 16 is selected such that all rays a emitted directly from the LED 13 are blocked. This extent of the side guards 15, 16 is thus determined by the dimensions of the rod 11, the position of the LED and the refractive index of the rod 11.

The LED 13 may be mounted on a PCB 14 itself mounted on an end face 18. The end face 18 may be connected to the side guards 15, 16. The end face and/or side guards may be made from metal and thus provide a heat sink. The skilled man will also appreciate that the LED 13 may be replaced by an array of multiple LEDs if desired or appropriate.

FIGS. 3a and 3b illustrate schematically lighting units 20 incorporating lighting devices 10 according to the present invention. In FIG. 3a, the lighting unit has a housing 21 comprising end caps 25 (which can include the features of either end cap embodiment discussed above) and low side panels 22. In such embodiments, the reflective strip 12 is covered by the low side panels 22. In FIG. 3b, the lighting unit differs from that in FIG. 3a only by having high side panels 23, so as to further collimate the diffuse beam provided by lighting device 10.

Turning now to FIG. 4, it is possible to combine a plurality of rods 11 into a single lighting unit 100. The housing 101 of the unit 100 is adapted at opposing ends 125 to provide mounting for the LEDs 13 and side guards 16, 15 for the ends of the rods 11 adjacent to the LEDs 13. In such embodiments, the reflective strip 12 may be provided at the rear of the rods 11 such that light is emitted outward from the unit 100. To further collimate the emitted light, opposing sides of the housing 123 may be adapted to act as high side panels such as those in FIG. 3b, although the skilled man will appreciate that low side panels could have been substituted for the high side panels 123. Typically, such a unit may be adapted to be substantially equal in size to a ceiling tile.

FIG. 4 shows an alternative embodiment by means of which a plurality of rods 11 can be combined into a single lighting unit 200. In this case, the rods 11 are provided along each side of a substantially square housing 201. At each vertex of the square housing are provided blocks 125 adapted to provide mounting for the LEDs 13 and side guards 16, 15 for the ends of the rods 11 adjacent to the LEDs 13. Between the blocks 225 are provided low side panels 222 although the skilled man will appreciate that high side panels could have been substituted for the low side panels 222. It is of course to be understood that the present invention is not to be restricted to the details of the above embodiment which is described by way of example only.

1. A lighting device comprising:
a substantially transparent body;
a reflector provided along the body;
an end face having one or more LEDs mounted thereon so as to emit light into the body; and
side guards provided at the end of the body adjacent to the or each LED and covering the side of the body such that they substantially block the escape of light directly emitted from the LEDs that would not be totally internally reflected from the side of the body.

2. A lighting device as claimed in claim 1 wherein the or each LED is mounted upon one or more portions of printed circuit board (PCB) mounted on the end face.

3. A lighting device as claimed in claim 1 wherein the end face is adapted to incorporate or act as a heat sink for the or each LED.

4. A lighting device as claimed in claim 1 wherein the interior of the side guards comprises a non-reflective surface, a diffusely reflective surface or a combination thereof.

5. A lighting device as claimed in claim 1 wherein the extent of the side guards is determined from consideration the mounting position of the or each LED and the refractive index of the body.

6. A lighting device as claimed in claim 1 wherein the side guards are substantially parallel to the sides of the body.

7. A lighting device as claimed in claim 1 wherein the end cap forms part of a housing for mounting the lighting device.

8. A lighting device as claimed in claim 1 wherein the body is formed from acrylic.

9. A lighting device as claimed in claim 1 wherein the body is in the form of an elongate rod.

10. A lighting device as claimed in claim 9 wherein the rod has a substantially circular cross-section.

11. A lighting device as claimed in claim 1 wherein the reflector is a diffusely reflective strip.

12. A lighting device as claimed in claim 11 wherein the strip is a white tape or white material applied to or attached to the body.

13. A lighting device as claimed in claim 1 wherein the reflector is elongate and is provided along the side of the body and parallel to the axis of the body.

14. A lighting device as claimed in claim 1 wherein the device is provided with one or more additional reflectors.

15. A lighting device as claimed in claim 14 wherein an end reflector is provided at the end of the body opposite the end face.

16. A lighting device as claimed in claim 15 wherein the end reflector is a diffuse reflector.

17. A lighting device as claimed in claim 15 wherein the end reflector is a mirror reflector provided within side guards.

18. A lighting device as claimed in claim 1 wherein an end face having one or more LEDs mounted thereon and associated side guards is provided at either end of the body.

19. A lighting unit comprising:
one or more substantially transparent bodies, the or each body having a reflector provided along the body; a housing for retaining the or each body in a desired position wherein the housing is adapted to provide, at least one end of the or each body: an end face having one or more LEDs mounted thereon so as to emit light into the body; and side guards covering the side of the body adjacent to the end face such that they substantially block the escape of light directly emitted from the LEDs that would not be totally internally reflected from the side of the body.

20. A lighting unit as claimed in claim 19 wherein the housing comprises one or more side panels.

21. A lighting unit as claimed in claim 20 wherein the side panels are adapted to help collimate light from the reflector.

22. A lighting unit as claimed in claim 19 wherein in embodiments comprising more than one body, the bodies are adapted such that they are arranged substantially spaced apart.

23. A lighting unit as claimed in claim 19 wherein in embodiments comprising more than one body, the bodies are adapted such that they are arranged substantially adjacent to one another.

24. A lighting unit as claimed in claim 19 wherein in embodiments comprising more than one body, the plurality of bodies are arranged such that they lie along a common axis to each other body.

25. A lighting unit as claimed in claim 19 wherein in embodiments comprising more than one body, the plurality of bodies are arranged such that they lie along parallel axes to each other body.

26. A lighting unit as claimed in claim 19 wherein in embodiments comprising more than one body, the plurality of bodies are arranged such each body is orientated at an angle with respect to the adjacent body.

27. A lighting unit as claimed in claim 26 wherein the bodies are rods arranged along sides of a polygonal housing.
